(19) United States
(12) Patent Application Publication
(10) Pub. No.: US 2023/0056092 A1
(43) Pub. Date: Feb. 23, 2023

(54) ROAD INSTALLATION CHECK SYSTEM

(71) Applicant: TOYOTA JIDOSHA KABUSHIKI KAISHA, Toyota-shi Aichi-ken (JP)

(72) Inventor: Mashio Taniguchi, Toyota-shi Aichi-ken (JP)

(73) Assignee: TOYOTA JIDOSHA KABUSHIKI KAISHA, Toyota-shi Aichi-ken (JP)

(21) Appl. No.: 17/890,792

(22) Filed: Aug. 18, 2022

(30) Foreign Application Priority Data
Aug. 23, 2021 (JP) 2021-135534

(51) Int. Cl. G06T 7/00; G06T 7/70; G06Q 30/02

(52) U.S. Cl. CPC G06T 7/0002; G06T 7/70; G06Q 30/0208; G06T 2207/30184; G06T 2207/30168

(57) ABSTRACT

A road installation check system that collects an image of a road installation and checks a condition of the road installation includes a photographing device that captures the image, and a road installation check device that collects the image captured by the photographing device and a photographing position and check the condition of the road installation. The road installation check device gives an incentive to a user of the photographing device in exchange of the image.

### CROSS-REFERENCE TO RELATED APPLICATION

This application claims priority to Japanese Patent Application No. 2021-135534 filed on Aug. 23, 2021, incorporated herein by reference in its entirety.

### BACKGROUND

### 1. Technical Field

The present disclosure relates to a road installation check system that collects images of road installations and checks the conditions of the road installations.

### 2. Description of Related Art

Road installations are provided for ensuring the safety of road traffic and improving convenience for road users, for example, and include medians, traffic signals, road signs, road lights, pedestrian signals, pedestrian crossings, guardrails, street lights, and others. The road installations are managed by local governments such as municipalities (e.g., city, town, or village). Deterioration of a road installation has adverse effects on road users or socioeconomic activities. Thus, the municipalities need to check the conditions of the road installations including deterioration or damage.

For example, Japanese Unexamined Patent Application Publication No. 2020-086669 (JP 2020-086669 A) discloses a road installation check system that checks the conditions of road installations such as pedestrian crossings, using an on-board camera mounted on a vehicle.

### SUMMARY

However, in the road installation check system disclosed in JP 2020-086669 A, it is necessary to extract only the images that enable the conditions of the road installations to be checked, from a large quantity of images, which is extremely costly and time-consuming.

The present disclosure provides a road installation check system that can easily collect a large quantity of images that enable the conditions of road installations to be checked.

A road installation check system according to the present disclosure, which collects an image of a road installation and checks a condition of the road installation, includes a photographing device configured to capture the image, and a road installation check device configured to collect the image captured by the photographing device and a photographing position and check the condition of the road installation. The road installation check device is configured to give an incentive to a user of the photographing device in exchange of the image.

In the road installation check system described above, the photographing device may have a character display unit configured to display a character image on a photographing screen of the photographing device when the road installation fits in the photographing screen at a predetermined ratio from a predetermined direction.

In the road installation check system described above, the road installation check device may give the incentive to the user of the photographing device depending on whether the image enables the road installation check device to check deterioration of the road installation.

In the road installation check system described above, the road installation check device may have a condition determining unit configured to determine the condition of the road installation based on the image collected.

In the road installation check system described above, the road installation check device may be configured to inform the user of the photographing device close to the road installation determined by the condition determining unit to be deteriorated of the presence of the road installation determined to be deteriorated close to the user.

According to the road installation check system of the present disclosure, it is possible to easily collect a large quantity of images that enable the condition of the road installation to be checked, by having the user of the photographing device take pictures of the road installation just for fun.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1 is a schematic view showing a road installation check system as one embodiment;

FIG. 2 is a block diagram showing the configuration of the road installation check system as the embodiment; and

FIG. 3 is a flowchart illustrating the flow of collecting images of road installations by the road installation check system as the embodiment.

### DETAILED DESCRIPTION OF EMBODIMENTS

One embodiment of the present disclosure will be described in detail. In the following description, specific shapes, materials, directions, numerical values, etc. are examples to facilitate understanding of the present disclosure, and may be changed as appropriate to suit the application, purpose, specifications, etc.

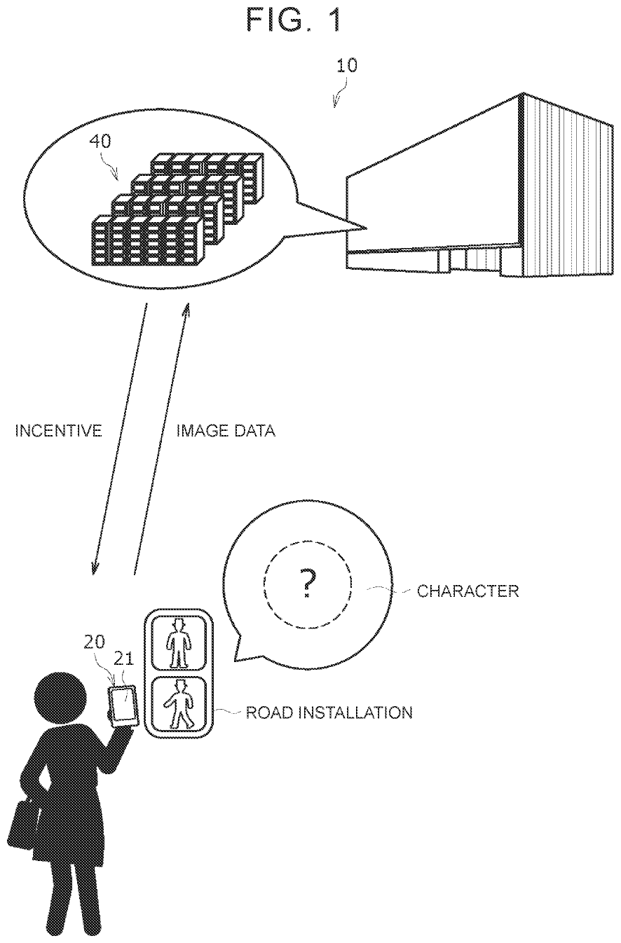

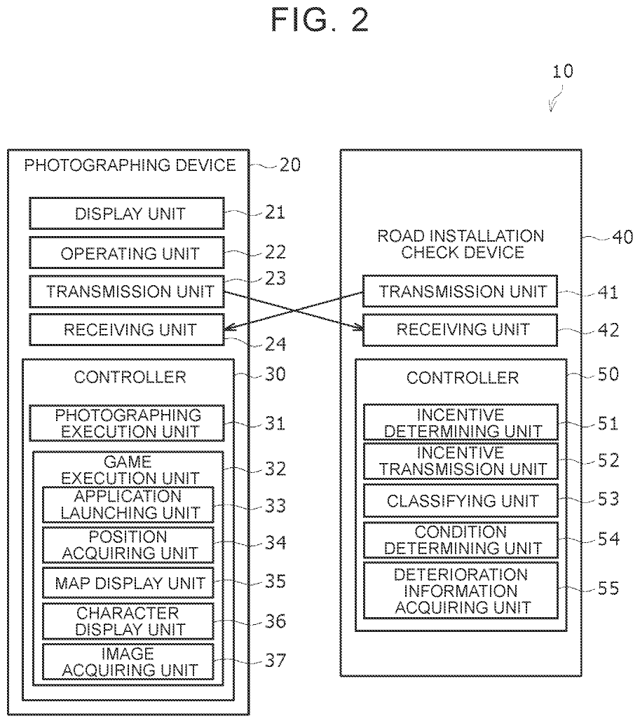

Referring to FIG. 1 and FIG. 2, a road installation check system 10 will be described.

The road installation check system 10 is a system that collects image data of road installations, and checks the conditions of the road installations based on the collected image data. The road installation check system 10 can easily collect a large quantity of images that enable the conditions of the road installations to be checked, by having the user of a photographing device 20 that will be described later execute a road installation image collection game and take pictures of the road installations.

The “road installations” include all installations provided for ensuring the safety of road traffic and improving the convenience of road users, etc. For example, the “road installations” include medians, traffic signals, road signs, road lights, pedestrian signals, pedestrian crossings, guardrails, street lights, etc.

The “conditions of a road installation” include the deteriorated or damaged state of the road installation, and may be expressed such that “there is currently no problem in the condition of the road installation”, “the road installation is deteriorating and needs to be monitored”, and “the road installation is deteriorating or damaged and needs to be repaired,” for example. The “deterioration or damage of the road installation” includes, for example, peeling paint at pedestrian crossings, traffic signal failure, broken road signs, and so forth.

The road installation check system 10 is owned by a local government such as a municipality (city, town, or village). The road installation check system 10 sets a road installation that is managed by the municipality and has been installed for a predetermined number of years, for example, as a target of checking.

The road installation check system 10 includes a photographing device 20 that captures images of a road installation, and a road installation check device 40 that collects image data and photographing positions of the images captured by the photographing device 20 and checks the condition of the road installation.

The photographing device 20 is used by an individual (hereinafter referred to as “user”) registered with the road installation check system 10. The photographing device 20 captures images of the road installation, and sends the captured images to the road installation check device 40. In some embodiments, a smartphone with a camera function is used as the photographing device 20. The photographing device 20 is not limited to the smartphone, but may be a mobile phone with a camera function.

The photographing device 20 has a display unit 21 on which a photographing screen or a map, for example, is displayed, an operating unit 22 with which the photographing device 20 is operated, a transmission unit 23 that transmits the image data of the captured images to the road installation check device 40, a receiving unit 24 that receives position information on the road installation that has been determined to be deteriorated as described later, or an incentive that will be described later, which is transmitted from the road installation check device 40, and a controller 30 that allows the user of the photographing device 20 to execute the road installation image collection game.

The controller 30 has a central processing unit (CPU) as a computing unit, and a storage such as a random access memory (RAM), a read-only memory (ROM), etc., and performs signal processing according to programs or applications stored in advance in the ROM while using the temporary storage function of the RAM.

The controller 30 has a photographing execution unit 31 that causes the photographing device 20 to capture images, and a game execution unit 32 that executes a game (hereinafter referred to as “road installation image collection game”) to capture images of road installations and obtain incentives.

The photographing execution unit 31 captures an image displayed on the display unit 21 through operation of the operating unit 22, using the display unit 21 as a photographing screen.

The game execution unit 32 has an application launching unit 33 that launches an application for executing the road installation image collection game, a position acquiring unit 34 that acquires the current position of the photographing device 20, and a map display unit 35 that displays the current position of the photographing device 20 and the road installation to be checked on a map in the display unit 21. The game execution unit 32 also has a character display unit 36 that displays a character image superposed on the road installation on the display unit 21 (the photographing screen) when the road installation fits in the photographing screen at a predetermined ratio from a predetermined direction to the photographing screen, to induce the user to capture an image of the road installation, and an image acquiring unit 37 that acquires image data of the captured image

The position acquiring unit 34 acquires the current position of the photographing device 20 with a global positioning system (GPS) installed in the photographing device 20.

The map display unit 35 displays the current position of the photographing device 20 and the road installation to be checked on the map in the display unit 21, as described above. With the map display unit 35, it is possible to confirm where is the road installation to be checked on the map. The map may not be an actual map, but may be a virtual field map that is linked to the real map, with characters representing the current position of the photographing device 20 and the road installation to be checked.

The character display unit 36 displays a character image superposed on the road installation on the display unit 21 (the photographing screen) using AR technology (overlaying virtual visual information on real scenery for display) when the road installation fits in the photographing screen at a predetermined ratio from a predetermined direction to the photographing screen, as described above.

“The road installation fits in the photographing screen at a predetermined ratio from a predetermined direction” when the image is captured in such a direction that the deteriorated or damaged state of the road installation can be sufficiently recognized from the image, and the size of the road installation relative to the photographing screen is large enough to allow the deteriorated or damaged state of the road installation to be sufficiently recognized from the image. The predetermined direction and predetermined ratio may be different for each road installation.

The character display unit 36 displays the character in a condition where the road installation fits in the photographing screen at the predetermined ratio from the predetermined direction, so that the user can be made aware that he/she may capture an image of the road installation in this condition in the road installation image collection game.

The road installation check device 40 is installed in a municipal data center that owns the road installation check system 10, and collects image data and photographing positions of the images captured by the photographing device 20 to check the conditions of road installations. The road installation check device 40 also gives an incentive that will be described later to the photographing device 20 that transmitted the image data, in exchange of the image data.

The road installation check device 40 has a transmission unit 41 that transmits position information of the road installation determined to be deteriorated as described later, or the incentive, to the photographing device 20, a receiving unit 42 that receives image data obtained by the photographing device 20, and a controller 50 that checks the condition of the road installation including deterioration or damage of the road installation.

The controller 50 has CPU as a computing unit, and a storage such as RAM and ROM, and performs signal processing according to programs stored in advance in the ROM, using the temporary storage function of the RAM.

The controller 50 has an incentive determining unit 51 that determines an incentive for the transmitted image data of the road installation, an incentive transmission unit 52 that transmits the determined incentive to the user of the photographing device 20, a classifying unit 53 that classifies the transmitted image data of road installations for each road installation, a condition determining unit 54 that determines the condition of a given road installation, based on the image data classified for each road installation, and a deterioration information acquiring unit 55 that collects more image data of the road installation determined to be deteriorated.

The incentive determining unit 51 determines the incentive for the transmitted image data of the road installation, according to the degree by which the condition of the road installation can be checked based on the image data. More specifically, more incentives than normal will be granted when the condition of the road installation can be checked more prominently.

“The degree by which the condition of the road installation can be checked” is determined by comprehensively determining, for example, the focus of the image, the resolution of the image, the brightness of the image, the percentage of the road installation in the image, and so forth.

The “incentives” refer to rewards for image data from which the conditions of road installations can be checked, and include electronic money, points that can be used on predetermined shopping sites, points that can be exchanged with cash, and so on.

The classifying unit 53 classifies the transmitted image data of road installations for each road installation and collects image data for each road installation.

The condition determining unit 54 determines the condition of the road installation, based on the image data collected for each road installation. The condition determining unit 54 may analyze the image(s) of the road installation, for example, and classify the condition of the road installation into three levels, such as Level A indicating that there is no problem at present, Level B indicating that the road installation is deteriorated and needs to be monitored, Level C indicating that the road installation is deteriorated and needs to be repaired, etc.

In order to collect more images of the road installation (hereinafter referred to as “deteriorated road installation”) determined as Level C, for example, by the condition determining unit 54, the deterioration information acquiring unit 55 induces the user of the photographing device 20 to photograph the deteriorated road installation,

The deterioration information acquiring unit 55 may inform the photographing device 20 present within a predetermined range of a deteriorated road installation of the presence of the deteriorated road installation. More specifically, the map display unit 35 displays the deteriorated road installation on the map in different color from other road installations, or displays the deteriorated road installation with a different character from other road installations. When the image of the deteriorated road installation is captured and transmitted, the incentive may be increased compared to the case where images of other road installations are captured and transmitted.

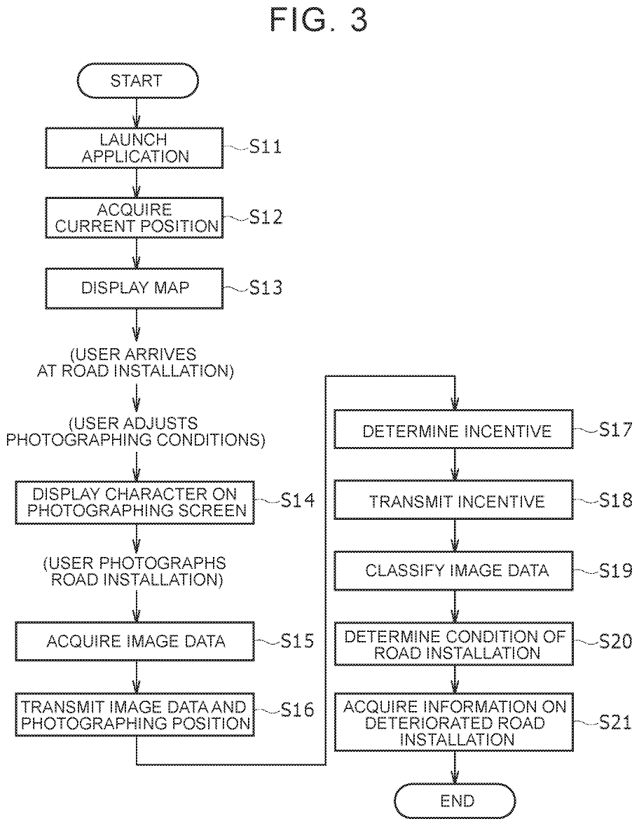

Referring to FIG. 3, the flow of collecting images of road installations by the road installation check system 10 will be described.

In step S11, the user of the photographing device 20 (smartphone) operates the operating unit 22 to launch the application for executing the road installation image collection game. In step S12, the current position is acquired by the position acquiring unit 34. In step S13, the map display unit 35 displays a map on which the current position and a target road installation (road installation set in the road installation image collection game) are displayed, on the display unit 21.

The user arrives at the target road installation based on the map, and adjusts the angle of view, etc., so that the target road installation fits into the display unit 21 (photographing screen) in order to be photographed. At this time, in step S14, when the road installation fits in the photographing screen at a predetermined ratio from a predetermined direction, the character display unit 36 displays a character image (character set in the road installation image collection game) superposed on the road installation on the photographing screen. Then, the user photographs the road installation by the photographing execution unit 31. In step S15, image data of the image captured by the image acquiring unit 37 is acquired.

In step S16, the transmission unit 23 of the photographing device 20 transmits the image data and photographing position information of the road installation to the receiving unit 42 of the road installation check device 40. In step S17, the incentive determining unit 51 determines the incentive according to the degree by which the condition of the road installation can be checked with the transmitted image data of the road installation. In step S18, the incentive transmission unit 52 transmits the determined incentive to the receiving unit 24 of the photographing device 20 via the transmission unit 41.

In step S19, the classifying unit 53 classifies the transmitted image data of road installations for each road installation. In step S20, the condition determining unit 54 determines the condition of the road installation based on the image data collected for each road installation. In step S21, the deterioration information acquiring unit 55 induces the user of the photographing device 20 to photograph the deteriorated road installation so as to collect more images of the deteriorated road installation.

The present disclosure is not limited to the above-described embodiment and its modified examples, but, needless to say, various modifications and improvements are possible within the range of the matters described in the claims of this application.

For example, a walking support system that recognizes road installations, using surveillance cameras, to assist the visually impaired in walking needs to learn images of a large quantity of road installations. Thus, the road installation check system 10 according to this disclosure may also be used when a large quantity of road installation image data is collected.

What is claimed is:

1. A road installation check system that collects an image of a road installation and checks a condition of the road installation, comprising:
a photographing device configured to capture the image; and
a road installation check device configured to collect the image captured by the photographing device and a photographing position and check the condition of the road installation,
wherein the road installation check device is configured to give an incentive to a user of the photographing device in exchange of the image.

2. The road installation check system according to claim 1, wherein the photographing device has a character display unit configured to display a character image on a photographing screen of the photographing device when the road installation fits in the photographing screen at a predetermined ratio from a predetermined direction.

3. The road installation check system according to claim 1, wherein the road installation check device gives the incentive to the user of the photographing device depending on whether the image enables the road installation check device to check deterioration of the road installation.

4. The road installation check system according to claim 1, wherein the road installation check device has a condition determining unit configured to determine the condition of the road installation based on the image collected.

5. The road installation check system according to claim 4, wherein the road installation check device is configured to inform the user of the photographing device close to the road installation determined by the condition determining unit to be deteriorated of a presence of the road installation determined to be deteriorated close to the user.
